(19) United States
(12) Patent Application Publication
(10) Pub. No.: US 2026/0058829 A1
(43) Pub. Date: Feb. 26, 2026

(54) IMPROVED BLOCKCHAIN SYSTEM AND METHOD

(71) Applicant: BTQ AG, Vaduz (LI)

(72) Inventors: Po-Chun KUO, Taipei City (TW); Chen-Mou CHENG, Taipei City (TW)

(21) Appl. No.: 19/103,296

(22) PCT Filed: Aug. 14, 2023
(86) PCT No.: PCT/EP2023/072417

§ 371 Date: Feb. 12, 2025

(30) Foreign Application Priority Data
Aug. 14, 2022 (EP) 22190335.4

(51) Int. Cl. H04L 9/32; H04L 9/00; H04L 9/08; H04L 9/30

(52) U.S. Cl. CPC H04L 9/3255; H04L 9/0825; H04L 9/3093; H04L 9/3218; H04L 9/3236; H04L 9/50

(57) ABSTRACT

Systems and methods are provided for collecting anonymized drive information. A processing device may be configured to receive outputs from one or more sensors; determine at least one motion representation for the host vehicle based on the outputs; receive at least one image representative of an environment of the host vehicle; analyze the at least one image to determine at least one road characteristic associated with a road section; assemble first road segment information relative to a first portion of the road section, wherein the first portion of the road section is separated from a starting point associated with a route traveled by the host vehicle; assemble second road segment information relative to a second portion of the road section; and cause transmission of the first road segment information and the second road segment information to a server for assembly of an autonomous vehicle road navigation model.

### FIELD OF THE INVENTION

The present disclosure relates generally to blockchain technology, and in particular to a system and a method for aggregating signatures associated with different transactions together in a block of a blockchain.

### BACKGROUND OF THE INVENTION

Quantum computers threaten to break the security mechanisms underpinning modern blockchain technology. There is already a known attack vector for the Elliptic Curve Digital Signature Algorithm (ECDSA), the cryptographic system responsible for protecting the authenticity and validity of transactions in current blockchains. Finding a post-quantum solution to replace ECDSA in blockchains is not trivial. Use of post-quantum cryptography (PQC) schemes such as lattice-based cryptographic schemes entail larger key and digital signature sizes, which impact the overall size of ledgers and transactional throughput of a blockchain network. Enhancing blockchain security requires a more nuanced approach than merely substituting current algorithms with post-quantum cryptographic (PQC) ones.

### SUMMARY OF THE INVENTION

Aggregating signatures provides a promising solution to at least some of the aforementioned problems with the prior art, and strikes a balance between heightened security, whilst mitigating for the potential drawbacks associated with larger key and signature sizes in post-quantum cryptographic schemes. Through signature aggregation, multiple signatures can be combined into a single aggregated signature, optimizing the use of cryptographic resources, and minimizing the overhead associated with larger keys. This approach not only enhances the efficiency of blockchain operations but also strengthens the security of the network against potential quantum-based attacks on cryptographic algorithms.

In accordance with an aspect of the disclosure, there is provided a method of aggregating a plurality of signatures together into a block of blockchain. Each signature may be associated with a different transaction. The method may comprise receiving a plurality of different transactions. Each transaction may comprise transaction data and associated signature data. The method may further comprise aggregating the signature data associated with the plurality of received transactions to generate an aggregated signature and generating a block of a blockchain, the block comprising the transaction data and the aggregated signature. The aggregated signature may be maintained separate from the transaction data in the generated block. At least some of the herein-disclosed embodiments result in a significant reduction in the size of the aggregated signature, when compared with prior art solutions of individually storing each signature associated with each transaction on the block of the blockchain. At least some of the herein-disclosed embodiments provide a post-quantum signature aggregation method capable of consolidating numerous post-quantum signatures such as lattice-based signatures.

In accordance with some embodiments, each transaction may be associated with a public key, pkᵢ, and private key, skᵢ, pair, the public and private key pair being selected using a digital signature scheme. The signature data, sᵢ, associated with a transaction may be generated by encrypting the transaction data, Tₓᵢ, associated with the transaction, using the private key, skᵢ, associated with the transaction. Aggregating the signature data associated with the plurality of received transactions to generate the aggregated signature may comprise using an aggregation algorithm in combination with the public key, pkᵢ, and the signature data, sᵢ, associated with each transaction and the plurality of transaction data, to generate the aggregated signature.

Aggregating the signature data associated with the plurality of received transactions to generate the aggregated signature, may comprise: sending the public key, pkᵢ, the signature data, sᵢ, and the transaction data associated with the plurality of transactions, to an aggregator configured to generate the aggregated signature using an aggregation algorithm; and receiving the generated aggregated signature.

In accordance with some embodiments, the digital signature scheme may be any one or more of: a multi-use signature scheme, a post-quantum digital signature scheme, a lattice-based cryptographic digital signature scheme. Where a lattice-based cryptographic digital signature scheme is used, the lattice-based cryptographic digital signature scheme may be a hash-and-sign lattice-based cryptographic digital signature scheme, such as the Falcon signature scheme.

In some of the herein disclosed embodiments, the generated aggregated signature may comprise a plurality of aggregated signature components. These components may comprise any one or more of: at least a portion of a composite expression, a composite expression, one or more outputs of a cryptographically-verifiable computing algorithm. The cryptographically-verifiable computing algorithm may comprise any one of: a probabilistic checkable proof; a zero-knowledge proof algorithm.

In some embodiments, aggregating the signature data associated with the plurality of received transactions to generate the aggregated signature, may comprise: determining, at least one composite expression for the received plurality of transactions based on any one or more of: the public key, pkᵢ, associated with the transaction, the transaction data, Tₓᵢ, associated with the transaction, at least one hash function; and determining, using the at least one determined composite expression as an input to a cryptographically verifiable computing algorithm, at least one component of the aggregated signature. The cryptographically verifiable computing algorithm may be a zero-knowledge proof algorithm, and the at least one determined composite expression may be used as a private witness.

In accordance with some embodiments, aggregating the signature data associated with the plurality of received transactions to generate the aggregated signature, may comprise: determining, for each transaction, a first parameter, rᵢ, by calculating rᵢ=hash(pkᵢ, Tₓᵢ), where pkᵢ is the public key associated with the transaction, and Tₓᵢ is the transaction data associated with the transaction; determining a first component, a₁, of the aggregated signature, A, by calculating, for each transaction, a first product rᵢ*s_{i,1}, where s_{i,1} is a first component of the signature data associated with a transaction, and summing the first product over all transactions to calculate the first aggregate signature component; determining a second component, a₂, of the aggregated signature, A, by calculating, for each transaction, a second product rᵢ*pkᵢ*s_{i,2}, where s_{i,2} is a second component of the signature data associated with a transaction, and summing the second product over all transactions to calculate the second aggregate signature component; and determining, using the second aggregate signature component, a₂, as an input to a cryptographically verifiable computing algorithm, a third component, π, of the aggregated signature, A.

In accordance with some embodiments, aggregating the signature data associated with the plurality of received transactions to generate the aggregated signature, may comprise: determining, for each transaction, a first parameter, qᵢ, such that s_{1,i}=Hash(Tₓᵢ)−pkᵢ s_{2,i}+qᵢ p, where pkᵢ is the public key associated with the transaction, Tₓᵢ is the transaction data associated with the transaction, s_{i,1} is a first component of the signature data associated with the transaction, s_{i,2} is a second component of the signature data associated with the transaction, Hash(Tₓᵢ) is a hash value of the transaction data with Hash( ) a hash function, and p a prime number; and executing a zero-knowledge proof algorithm using as a private witness a set of the first parameter, the first signature component and the second signature component for the plurality of received transactions {s_{1,i}, s_{2,i}, qᵢ}. and using as a public instance a set of the public keys and the hash values of the transaction data for the plurality of received transactions {pkᵢ, Hash(Tₓᵢ)} to output the aggregated signature.

In at least some embodiments, a size of the aggregated signature is less than the sum of the sizes of each signature data associated with each transaction. In some embodiments, a size of the aggregated signature is sublinear with respect to the total number of transactions. In some embodiments, the size of the aggregated signature scales logarithmically with respect to the total number of transactions.

In accordance with some embodiments, the total number of transactions is greater than a threshold number of transactions for which the size of the aggregated signature is less than a sum of the sizes of each signature data associated with each transaction. In other words, the aggregated signature may be associated with a number of transactions greater than or equal to a threshold number of transactions. The sum of the sizes of each signature data associated with the threshold number of transactions is greater than the size of the aggregated signature associated with the threshold number of transactions. Thus, when the number of transactions associated with the aggregated signature is equal to or greater than the threshold number of transactions, the size of the aggregated signature is less than the sum of the individual signature sizes of each transaction.

In accordance with some embodiments, generating the block of the blockchain may comprise updating a pre-generated block, by replacing signature data comprised in the pre-generated block with the aggregated signature.

In accordance with some embodiments, the method may further comprise: running an aggregated signature verification algorithm using the aggregated signature, the plurality of transactions, and a plurality of public keys associated with the plurality of transactions.

In accordance with another aspect of the disclosure, there is provided a method of verifying a transaction in a block of a blockchain using an aggregated signature. The aggregated signature may be associated with a plurality of transactions in the block of the blockchain and may be stored in the block of the blockchain. The method may comprise receiving the aggregated signature, and verifying the validity of the transaction by executing an aggregated signature verification algorithm to verify the validity of the aggregated signature.

In accordance with yet a further aspect of the disclosure, there is provided a server comprising at least one processor configured to carry out the aforementioned method of aggregating a plurality of signatures together into a block of a blockchain.

In accordance with yet a further aspect of the disclosure, there is provided a server comprising at least one processor configured to carry out the aforementioned method of verifying a transaction in a block of a blockchain using an aggregated signature stored in the block of the blockchain, the aggregated signature being associated with a plurality of transactions in the block of the blockchain.

### BRIEF DESCRIPTION OF THE DRAWINGS

Exemplary, non-limiting embodiments of the disclosure will be described with reference to the appended figures in which:

FIG. 1 is a schematic diagram of a networked computer system in which the herein-disclosed methods may be implemented;

FIG. 2 is a schematic diagram of the Bitcoin blockchain illustrating the general structure and properties of a block;

FIG. 3 is a schematic diagram of a known blockchain illustrating how the signature is stored in a conventional blockchain;

FIG. 4 is a schematic diagram illustrating a blockchain comprising an aggregated signature block in accordance with embodiments of the present disclosure;

FIG. 5 is a schematic diagram illustrating how a blockchain comprising an aggregated signature algorithm may be used by a plurality of users to aggregate digital signatures on the blockchain, in accordance with embodiments of the present disclosure;

FIG. 6A is a process flowchart illustrating the steps comprised in a method of aggregating signatures from a plurality of different transactions, in accordance with some embodiments of the present disclosure;

FIG. 6B is a flowchart illustrating a method carried out to aggregate signatures from a plurality of different transactions together in the blockchain of FIG. 4;

FIG. 7 is a functional diagram illustrating how a miner of FIG. 1 generates an aggregated signature, in accordance with some embodiments; and

FIG. 8 outlines the functional modules comprised in the miner of FIG. 1 configured to generate the aggregated signature, in accordance with at least some embodiments of the disclosure.

### DETAILED DESCRIPTION

The following detailed description includes references to the accompanying drawings. Wherever possible, the same reference numbers are used in the drawings and the description to refer to the same or similar parts. While several illustrative embodiments are described herein, modifications, adaptations and other implementations are possible. For example, substitutions, additions, or modifications may be made to the components illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope is defined by the appended claims.

The herein-disclosed embodiments are directed to methods for aggregating digital signatures associated with different electronic transactions into a shared signature separate from the associated transaction data. In accordance with some embodiments, the aggregated signature's actual size may be smaller than the combined size of all individual signatures obtained through a digital signature scheme (e.g., a post-quantum signature scheme), such as a lattice-based digital signature scheme. The herein-disclosed embodiments may be implemented in the context of a blockchain network as well as in various other distributed systems, networks, cryptographic protocols, or secure communication platforms. The below index serves as an outline for the remaining disclosure.
1. System Overview
2. General structure of blockchains
3. General structure of blockchain blocks
   a. General structure and properties of the transaction data comprising a typical (e.g. Bitcoin) blockchain
   b. General structure and properties of the transaction data comprising the invented blockchain.
4. Exemplary embodiments
   a. “Hash and Sign” lattice-based cryptography
   b. Aggregation of signatures
   c. Use of Falcon signature algorithm
5. Alternative embodiments (alternative ways in which the invention principles could be implemented, which have not yet been described)
   a. Other potential signature algorithms that could also work with this method

### 1. System Overview

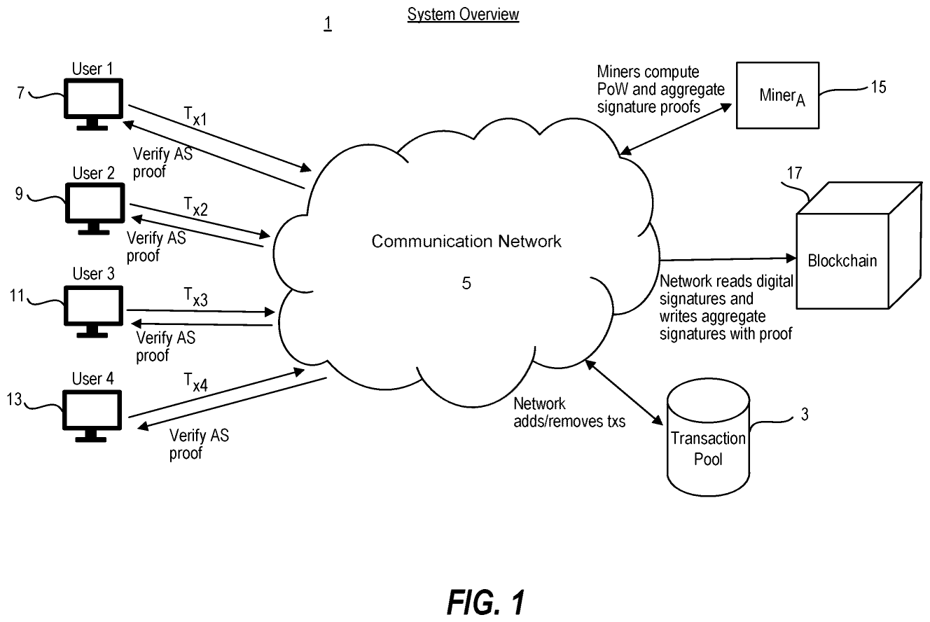

FIG. 1 is a schematic illustration of a networked computer system 1 in which embodiments of the present disclosure may be implemented. In particular, FIG. 1 illustrates the networked computer system 1 in which the signature data associated with electronic transactions may be aggregated together in a blockchain. The illustrated computer system may comprise a blockchain network, in which a ledger of electronic transactions is maintained on a blockchain.

Electronic transaction data generated by different users is collected together in a transaction pool repository 3, via a shared communication network 5. For example, first transaction data T_{X1} associated with a first user at a first user terminal 7, second transaction data T_{X2} associated with a second user at a second user terminal 9, third transaction data T_{X3} associated with a third user at a third user terminal 11, and fourth transaction data T_{X4} associated with a fourth user at a fourth user terminal 13, are sent to the transaction pool 3 via the shared communication network 5. Transaction data received by the transaction pool 3 is stored, and subsequently processed by at least one blockchain miner server 15.

In accordance with some embodiments, once a predetermined threshold condition is satisfied, the at least one blockchain miner server 15 may obtain a plurality of the transaction data (T_{X1} . . . . T_{X4}) stored in the transaction pool 3. For example, the predetermined threshold condition may relate to a predetermined number of electronic transactions stored at the transaction pool 3, such that a plurality of transaction data is bulk processed by the at least one blockchain miner server 15. In some embodiments, once the stored transaction data reaches a predetermined number of transactions, the at least one blockchain miner server 15 is provided with the plurality of transaction data and processes this transaction data to generate a new block to be added to an existing blockchain, and/or to generate a new blockchain. The precise manner in which new blocks are generated is immaterial to the present disclosure, and the herein-disclosed method of aggregating transaction signatures may be implemented in accordance with any blockchain system. Returning to the example of FIG. 1, the at least one blockchain miner server 15 processes the received transaction data to aggregate the signatures associated with the different electronic transactions together in a blockchain. The blockchain itself may additionally comprise the transaction data, such that the resulting blockchain comprises both the electronic transaction data and each associated signature. This enables the electronic transaction data comprised on the blockchain to be verified using the signature data. Storing the aggregated signature data together separate from the associated transaction data within the block results in a reduction of the storage requirements when compared with conventional known blockchain solutions in which the signature data is stored together with the associated electronic transaction data. This advantage will become clearer from the more specific embodiments disclosed below.

To assist the reader's understanding of the disclosure, some background information useful for better understanding the disclosure regarding blockchains is set out below, followed by a more detailed description of how the signature aggregations methods of the present disclosure may be implemented by the blockchain miner server 15 illustrated in FIG. 1.

It is also to be appreciated that whilst the system of FIG. 1 illustrates a single blockchain miner server 15, the number of blockchain miner servers comprised in the system is immaterial, provided there is at least one blockchain miner server. In systems comprising two or more blockchain miner servers 15, the different blockchain miner servers may compete with each other to generate the next block in the blockchain, as occurs in conventional blockchain systems. In this regard, the herein-disclosed signature aggregation methods are compatible with known blockchain systems.

### 2. General Structure of Blockchains

By way of background, a blockchain is a distributed ledger representing all transactions that take place within the network, such as the computerised network 1 of FIG. 1. Transaction data is permanently stored in files called blocks, and blocks are organised linearly in a chain-like structure over time, referred to as a “blockchain.” As new transactions take place, new blocks are created and appended to the end of the blockchain. Accordingly, the blockchain provides a ledger comprising a record of all transactions that have occurred over time. This is the fundamental structure of the blockchain.

### 3. General Structure of Blockchain Blocks

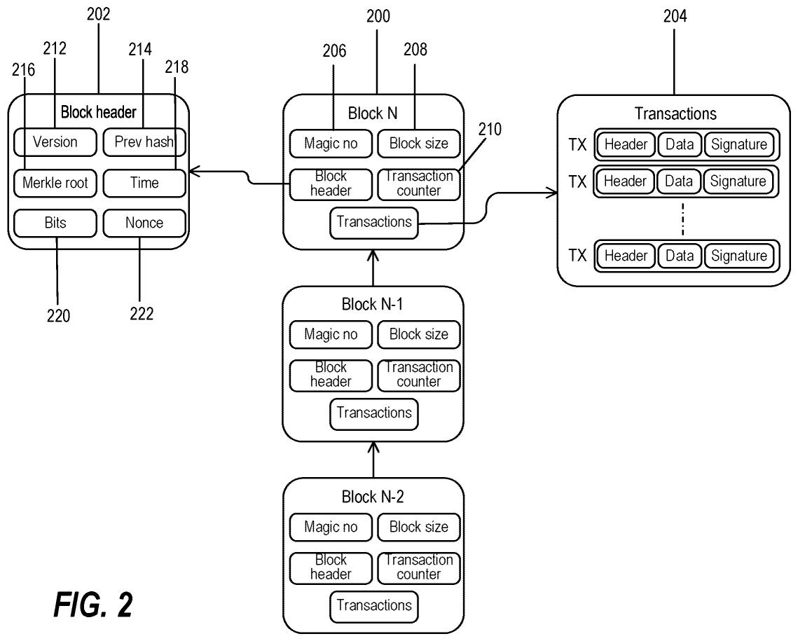

The structure of the blocks comprised in the blockchain is now described. As illustrated in FIG. 2, each block can be separated into three sections:
Block metadata [200]
Block header [202]
Transaction data [204]

Block metadata [200] may comprise general properties of the current block. This may include, but is not limited to:
Magic number (file signature) [206]—Indicates the type of data contained in the file. Same for all blocks belonging to the same blockchain.
Size of the current block [208]—Number of bytes following up to the end of the block
Number of transactions in the current block [210]

A block header describes particular properties of the current block such as its time and position. This may include but is not limited to:
Block version [212]—Specifies the current version of the blockchain software
Hash of previous block header [214]—Reference to the previous block
Hash of all transactions in the block [216]—Merkle root hash of all transactions in the block
Timestamp [218]—Current block timestamp Unix time (seconds since 1970-01-01T00:00 UTC)
Bit difficulty [220]—Current mining difficulty target
Nonce [222]—Number of attempts to solving Proof-of-Work (starts at 0)
   3a General Structure and Properties of the Transaction Data Comprising a Typical (e.g. Bitcoin) Blockchain

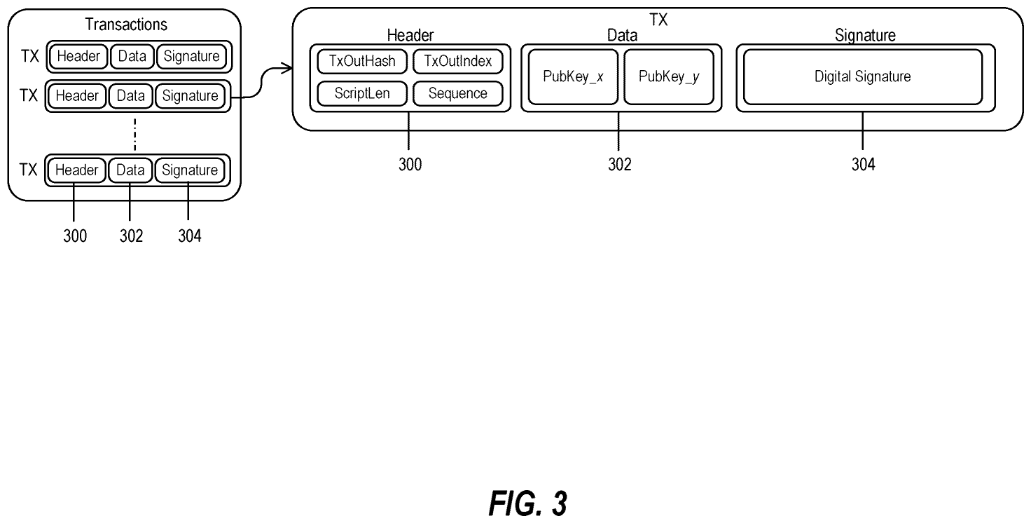

Transactions represent a transfer of some resource between two or more accounts on the blockchain. In some embodiments, the resource may relate to a financial resource, such as a transfer of funds. A transaction references previous transaction outputs as new transaction inputs and dedicates all underlying currency values to new outputs. This is formally realised as a state transition function, where each state represents the ownership status of all digital currency in circulation. It should be noted that a blockchain may comprise any type of transaction data, but for the non-limiting purpose of describing the invention we will assume that the blockchain is being used as a ledger for financial transactions. FIG. 3 illustrates the schematic representation of how transaction data is stored in a block of a typical blockchain. Transaction data is stored in three groups:
Header [300]—Contains instructions for sending the underlying currency. Includes a hash of a previous transaction and the output of the referenced transaction. The output of the referenced transaction is used as input to the current transaction.
Data [302]—Recipient public key.
Digital signature [304]—Within the context of a digital signature scheme, a digital signature is produced by an algorithm such as the Elliptic Curve Digital Signature Algorithm (ECDSA) currently employed in the Bitcoin blockchain over a hash of a simplified version of the transaction. This is used to prove that the transaction was created by the real owner of the underlying currency involved in the transaction.

Note the one-to-one relationship between each transaction and the digital signature.

Digital signatures are the results of asymmetric cryptography schemes, a type of cryptographic technique where a key used for encrypting data (private key) is distinct from a key used for decrypting the data (public key). Asymmetric cryptography schemes are also known as digital signature schemes.

In a public/private key scheme or digital signature scheme, a sender follows a specific process to ensure confidentiality, authenticity, and non-repudiation of a message being sent to a receiver. The following steps may be comprised in the process:
1. Message Signing with the Sender's Private Key: The sender first signs the message using their private key. This process involves creating a digital signature of the message. The digital signature is a unique cryptographic representation of the message that is generated using the sender's private key. It provides a means of proving that the message was sent by the sender possessing the private key and that the message has not been altered in transit.
2. Message Encryption with the Receiver's Public Key: After signing the message, the sender encrypts the entire message (including the digital signature) using the receiver's public key. The public key is part of the recipient's public/private key pair. Since the public key is meant to be freely distributed, anyone can use it to encrypt messages intended for the recipient.
3. Sending the Encrypted and Signed Message: The sender then sends the encrypted and signed message to the recipient. The recipient is the only one who possesses the corresponding private key that can decrypt the message and verify the digital signature.
4. Recipient's Decryption and Signature Verification: Upon receiving the message, the recipient uses their private key to decrypt the message and recover the original content, including the digital signature. The recipient can then verify the digital signature using the sender's public key, which is widely available. If the digital signature is valid, it confirms the message's authenticity and integrity, as only the sender's private key could have generated the signature.

A digital signature scheme corresponds therefore to a cryptographic algorithm that allows the creation and verification of digital signatures, providing a means of ensuring the authenticity and integrity of digital messages or data. It is to be appreciated that in some alternative processes, encryption is not mandatory.

A digital signature scheme may be defined by a set of algorithms (KeyGen, Sign, Verify) that function as follows:
KeyGen(λ)→ (sk, pk): Taking λ a security parameter to indicate a desired level of security as an input, the KeyGen algorithm produces a new random key pair (sk, pk)∈K_{S}×K_{P}, where sk is the private key or secret signing key, pk is the corresponding public verification key, K_{S} a private key set, and K_{P} a public key set.
Sign(sk, μ)→s: Given the private key sk and a message μ (e.g., a transaction Tx), the Sign algorithm generates a signature s∈S, with S representing a signature set.
Verify(pk, μ, s)→b∈{0, 1}: The Verify algorithm takes the public verification key pk, a message μ, and a signature s as inputs and outputs a bit b, indicating whether the signature s is valid for the given message μ with the public verification key pk.

λ translates the level of security in digital signature schemes. It is a measure of how resistant the scheme is to various attacks, including brute-force attacks and sophisticated mathematical attacks. It quantifies the amount of computational effort required for an adversary to forge or break the digital signature, essentially determining the strength of the cryptographic scheme. The security level is commonly measured in bits and indicates the number of bits needed to represent the security parameter of the cryptographic scheme. For example, if a digital signature scheme has a security level of 128 bits, it means that an attacker would need to perform approximately 2¹²⁸ operations to break the scheme using the best-known cryptanalytic algorithm, e.g., by using a brute-force attack. The security level is often associated with the key sizes and other parameters of the lattice used in the scheme. A higher security level usually requires larger key sizes and more complex mathematical operations to ensure resistance against attacks. Larger key sizes, in turn, may impact the size of the signature s. As used herein, a size whether a signature size or a key size refers to the number of bits or bytes needed to store a representation of the signature/key. The larger the signature/key size, the more data is needed to represent the cryptographic signature/key. The representation of a signature or a key may take different formats, such as a bit string or a hexadecimal string. These formats are common ways to represent the binary data that constitutes the signature/key in a human-readable or machine-readable form. The choice between bit string and hexadecimal string may depend on factors such as the desired readability, data size, ease of handling, and compatibility with existing systems or protocols.

In certain cryptographic schemes, a signature may be represented by multiple components s=(s₁, . . . , s_{M})), where M is the total number of signature components. Each part or component may have a specific purpose and contributes to the overall validity of the signature. In some cryptographic schemes, one of the signature components may correspond to the actual signature itself generated with the signer's private key, representing the core cryptographic proof of authenticity and integrity. The other components, on the other hand, may serve to reinforce the complexity or enhance the security of the overall scheme. These additional components may include various mathematical constructs or values derived from the actual signature, the private and public keys, the message being signed, or other cryptographic elements. By incorporating these extra components, the scheme may achieve certain security properties, such as resistance against specific types of attacks or increased protection.

It is also to be appreciated that signatures may be classified as either one-time-use or multi-use, based on their intended purpose and design. One-time-use signatures, as their name suggests, are meant for a single transaction or message. In these schemes, each key pair is limited to a single use, which significantly restricts their practical application. The reason behind this restriction is that using the same key pair to produce multiple signatures may compromise the security of the key pair, revealing it or portions of it to other users. As a result, one-time-use signatures are less commonly deployed in real-world scenarios. Conversely, in many practical applications, such as in blockchain technology, multi-use signature schemes are widely used. Examples of such schemes include RSA and ECDSA. In multi-use signature schemes, a single public key can be used for multiple transactions or messages, making them more efficient and suitable for large-scale deployment in various cryptographic protocols and systems.

As mentioned above, the purpose of the Verify algorithm is to perform computations to verify the signature's validity. This step may involve verifying certain mathematical relationships or constraints to ensure that the signature corresponds to the given message and was generated using the correct private key sk. It may as well use a message digest h(μ), which may correspond to a fixed-size digest or hash value of the message u. Many verification algorithms are available, and the choice of the verification algorithm directly depends on the KeyGen and Sign algorithm selected. Some digital signature schemes may employ some cryptographically verifiable algorithms (e.g., RSA) to generate the signature, while others may employ some probabilistic proof algorithms or zero-knowledge proof algorithms.

Zero-knowledge proof (ZKP) algorithms are cryptographic protocols that allow one party (the prover) to prove to another party (the verifier) the validity of a statement without revealing any additional information (zero-knowledge) beyond the fact that the statement is true. In other words, the prover is providing proof of the validity of the statement to the verifier. One of the properties of a zero-knowledge proof is that it may be easily verifiable. The verifier should be able to efficiently verify the proof without needing to perform the same complex computation as the prover. ZKPs involve a private witness and a public instance, which may be used individually or in combination in the statement. The private witness is the secret information that the prover possesses and wants to prove knowledge of without revealing it to the verifier. The public instance, on the other hand, is the publicly available information. During the proof generation process, the prover uses the private witness and the public instance to construct the proof, which is then provided to the verifier. The verifier can then use the proof along with the public instance to verify the correctness of the proof without learning anything about the private witness.

In the context of digital signatures, ZKPs may be employed to prove the validity of a signature without revealing the actual contents of the signature or the private key used for signing (private witness). Zero-knowledge proofs are inherently probabilistic rather than deterministic. This probabilistic nature arises from the need for multiple rounds of interactions between the prover and the verifier to gradually build a higher level of assurance that the prover possesses the secret knowledge without revealing it. In these interactions, the verifier challenges the prover by asking specific questions or requesting computations that only someone with knowledge of the secret (e.g., private key or signature) could answer correctly.

As a result of these repeated interactions, ZKPs are often interactive protocols. During the interactions, the verifier poses challenges or questions to the prover, and the prover responds accordingly. The verifier accepts the proof only if the prover's responses demonstrate a deep understanding of the secret without actually disclosing the secret itself. However, this interactive reasoning may be transformed into a non-interactive protocol through the Fiat-Shamir Transform. This technique is employed to convert interactive identification protocols into non-interactive zero-knowledge proof systems. In this transformation, the verifier's random challenges are replaced with the result of a random oracle or a hash function (which the verifier can check to ensure that the prover has performed correctly to produce its randomness). This ensures that the challenges become unpredictable to the prover, guaranteeing the security of the non-interactive version and achieving the same effect as truly random verifier challenges. For instance, in a scenario where a signer (prover) has a function f and an image pk=f(sk) as their public key, they keep sk as their secret key. To sign a message μ, the prover provides a non-interactive zero-knowledge proof that they know sk (private witness) satisfying pk=f(sk), using the message μ to create the challenge H(μ) for the proof. Here, H is a public hash function or random oracle that maps u to something “random looking”. If the function f is one-way, then the verifier can be convinced that the proof could only have been created by the entity who knows sk, ensuring the security of the non-interactive zero-knowledge proof system. Examples of ZKPs include Zero-Knowledge Succinct Non-Interactive Argument of Knowledge (zk-SNARK) and Zero-Knowledge Scalable Transparent Argument of Knowledge (zk-STARK)

Zero-knowledge proofs (ZKPs) may use various mathematical techniques or intermediate expressions to encode the statement to prove depending on the context and requirements of the zero-knowledge proof system and/or the statement needing to be proved. Intermediate representations serve as structured and condensed representations of computations, breaking down the computation into mathematical constraints, logical operations, or algebraic structures to achieve a more efficient and concise representation. For example, in the case of zk-SNARK (Zero-Knowledge Succinct Non-Interactive Argument of Knowledge) proofs, the statement is broken down into simple units of arithmetic operations, such as addition, subtraction, multiplication, and division. These operations are then presented in the form of an arithmetic circuit, where inputs and arithmetic operations are represented as wires and gates in a directed acyclic graph (DAG). This graph evaluates a polynomial by processing the inputs and performing the arithmetic operations on them.

Within the zk-SNARK protocol, several intermediate representations play valuable roles:
R1CS (Rank 1 Constraint System): RICS is a set of constraints that allow the verification of each step in the arithmetic circuit and confirms that the output of the computation is as expected.
QAP (Quadratic Arithmetic Program): The prover utilizes QAPs to construct a proof of the statement. Instead of checking numerous individual constraints as in RICS, the QAP representation bundles all these constraints into a single constraint, making the verification more efficient.
Finally, QAP is employed in the zk-SNARK protocol to prove the assertion through interactions between the prover and verifier, providing a succinct and non-interactive argument of knowledge for the statement's validity.

The result of a ZKP algorithm may be a proof string or proof object, providing evidence to the verifier that the prover holds knowledge of a valid solution to a specific problem or statement. The proof is designed such that the verifier can efficiently verify its validity without gaining any knowledge about the prover's secret. When the proof is valid, the verifier can be assured that the prover indeed possesses the required knowledge without knowing any specifics about it. In the context of a digital signature scheme, the ZKP proof may be integrated as one of the components of the signature s and contribute to the overall size of the signature, or represent the signature s itself.

Traditional public-key cryptography relies on the difficulty of certain mathematical problems on classical computers, such as integer factorization or the discrete logarithm problem. However, the rise of quantum computers poses a threat to these cryptographic schemes as quantum computers may efficiently solve these problems, rendering current cryptographic algorithms vulnerable.

To address this potential threat, various post-quantum digital signature schemes have been developed. These schemes utilize mathematical structures like Euclidean lattices or symmetric-key primitives such as cryptographic hash functions, which are believed to be resistant to attacks even by large quantum computers.

In response to the growing concerns over quantum computers, the National Institute of Standards and Technology (NIST) initiated a process in 2016 to develop standards for post-quantum cryptography, including encryption and digital signature schemes. NIST's efforts to establish guidelines for post-quantum digital signatures aim to ensure that secure communication and digital authentication infrastructures remain robust and usable even in the presence of powerful quantum adversaries. In July 2022, NIST announced its plan to standardize three post-quantum digital signature schemes: Falcon, Dilithium, and SPHINCS+. However, it's worth noting that these post-quantum signature algorithms have larger public key and signature sizes compared to their pre-quantum counterparts like ECDSA, typically ranging from 30 to 100 times larger. As an example, for NIST security level 1 (λ≈128 bits), the sizes of cryptographic components in different signature schemes may be compared as follows. In the Falcon scheme, the public key is 897 bytes, the private key is 1281 bytes, and the signature is 690 bytes. Similarly, in the Dilithium scheme, the public key is 1184 bytes, the private key is 2800 bytes, and the signature is 2044 bytes. In contrast, the traditional ECDSA scheme has smaller sizes, with a public key of 64 bytes, a private key of 96 bytes, and a signature of 64 bytes. In the field of post-quantum cryptography (PQC) schemes, it is important to note that both one-time-use signatures, such as one-time hash-based signatures, and multi-use signatures, such as Falcon signatures, coexist as well.

Among the various post-quantum cryptographic (PQC) schemes, one family that stands out as particularly promising is the lattice-based signature schemes (e.g., Falcon and Dilithium). Lattice-based cryptography relies on the hardness of certain mathematical problems related to lattices, which are structures formed by periodic arrays of points in multi-dimensional space. The security of lattice-based schemes is based on the difficulty of a limited class of lattice problems ranging from the “Shortest Vector Problem” (SVP), the “Closest Vector Problem” (CVP), the “Short Integer Solution Problem” (SISP), or the “Ring Learning With Error Problem” (RLWEP), which are believed to be resistant to quantum attacks.

Efficient lattice-based signature schemes, whether in software or hardware implementations, often establish their security through proofs in the random oracle model. These schemes can be broadly categorized into two families: the hash-and-sign family (e.g., Falcon) and signatures based on identification schemes, employing the Fiat-Shamir heuristic (e.g., Dilithium) or a related variation.

In digital signature schemes following the hash-and-sign paradigm, a specific criterion is adhered to: prior to being signed, a message u undergoes a hashing process. This entails hashing u into a certain point h=H(μ), with the condition that h falls within the domain of a designated trapdoor function f. Subsequently, after the message has been hashed, it becomes eligible for signing, leading to the creation of s=f−1(h). Verification of the validity of a message/signature pair (σ, μ) hinges on a verification algorithm that ascertains whether the equation f(s)=H(μ) holds true. The connection between lattices and hash-and-sign signatures is rooted in the insight that a concise basis for a lattice could potentially provide the aforementioned trapdoor function. Conversely, digital signature schemes formulated within the Fiat-Shamir paradigm take a different approach. They commence as identification schemes and are then transformed through a Fiat-Shamir transformation, a process that facilitates their conversion into signature schemes.

In almost all lattice-based signature verification processes, a central computation involves computing lattice vectors using matrix-vector multiplication for verifying the validity of the lattice-based signature and ensuring the authenticity and integrity of the signed message. Additional steps may be further required such as performing a range check and ensuring that the norm of the signature is below a predetermined threshold value.

3b General Structure and Properties of the Transaction Data in Accordance with Embodiments of the Disclosure

The general principle of the disclosure is to aggregate the digital signatures [304] associated with different transactions together in a block separate from the associated transaction data [300, 302].

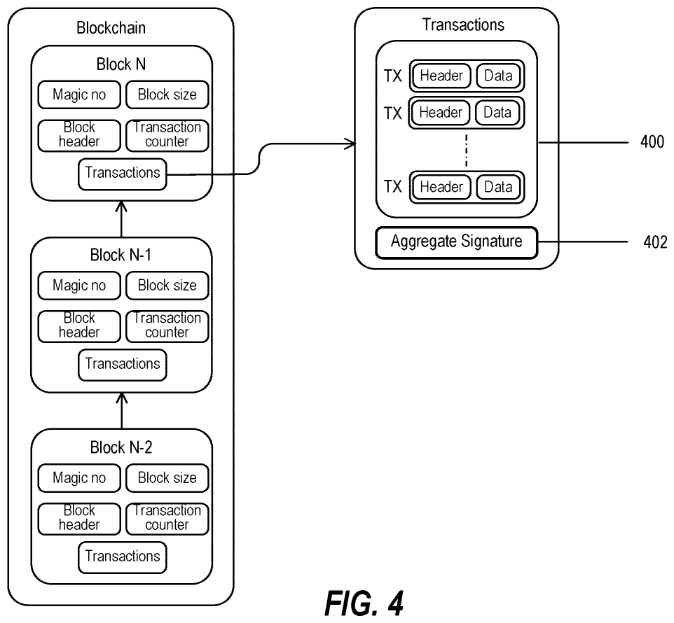

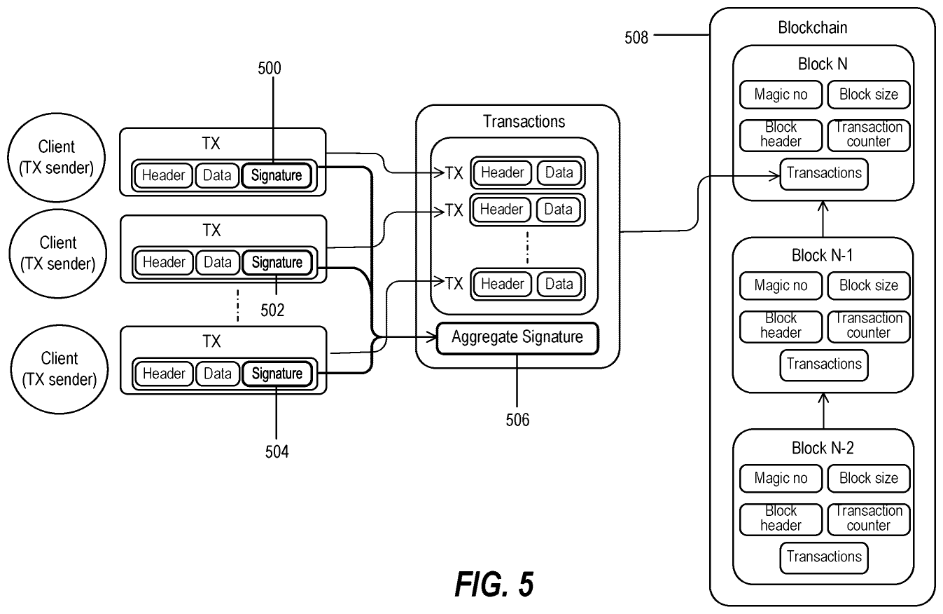

This allows the generated blockchain to reduce the overhead cost of storing one digital signature per transaction, thereby significantly reducing the size of the block. FIG. 4 is a schematic representation of how transaction data is stored in the blockchain in accordance with embodiments. This new technique preserves the structure of all transaction data 400 in FIG. 4 except for the digital signatures associated with each transaction, where the digital signatures associated with each transaction are combined into a single aggregate signature 402 in FIG. 4. FIG. 5 illustrates how a blockchain comprising an aggregated signature algorithm may be used by a plurality of users to aggregate digital signatures on the blockchain. Digital signatures 500, 502 and 504 in FIG. 5 are aggregated into a single aggregate signature 506 in FIG. 5 in order to reduce the memory requirement to store the signatures on the blockchain.

One of the primary goals of signature aggregation is to reduce the size and computational overhead of handling multiple signatures and to improve the efficiency and scalability of cryptographic operations. By aggregating multiple signatures into a single one, the overall data overhead may be reduced, leading to more efficient and manageable communication and storage.

In the context of a blockchain, where a plurality of transactions are bundled into a block, and each transaction is associated with a signature, signature aggregation may provide several advantages, enhancing the overall efficiency of the blockchain. For example, signature aggregation may significantly reduce the size of each block, by combining multiple signatures into a single aggregated signature. This reduction in block size directly translates to lower storage and bandwidth requirements, resulting in improved scalability and faster transaction processing. Another advantage of signature aggregation is that it may enable some of the computation related to the verification of signatures to be performed off-chain. Rather than executing all computations directly on the blockchain, which can be resource-intensive and slow, off-chain computation utilizes external devices to perform these computations. The results are then verified on-chain, which is more cost-effective than conducting all computations on-chain. The off-chain parties (referred to as the aggregator) may be untrusted and may not require communicating with the on-chain parties. This approach brings significant benefits to blockchain systems, including improved scalability and reduced on-chain resource requirements.

Within the context of PQC, where lattice-based or other post-quantum cryptographic schemes are used, the reduction in storage requirements associated with signature aggregation is particularly advantageous due to the larger key and signature sizes inherent in many PQC algorithms.

Incorporating an aggregation capacity in a digital signature scheme may comprise the addition of two algorithms (Aggregate, AggregateVerify) that function as follows:
Aggregate((μᵢ,pkᵢ,sᵢ)_{i=1:N})→A: Input a list of N message-key-signature triples (μ₁,pk₁,s₁), . . . , (μ_{N},pk_{N},s_{N}) and output an aggregate signature A.
AggregateVerify((μᵢ,pkᵢ)_{i=1:N}, A)→b∈{0, 1}: Input a list of N message-key pairs (μ₁,pk₁), . . . , (μ_{N},pk_{N}) and an aggregate signature A and output outputs a bit b, indicating whether the signature A is a valid aggregate signature for the given set of message-key pairs.

A digital signature scheme may therefore be defined by a tuple of algorithms (KeyGen, Sign, Verify, Aggregate, AggregateVerify). Some alternative algorithms may necessitate the participation and private keys (sk) of the signing entities in one or more rounds of interaction. Moreover, in certain scenarios, the Verify algorithm may be omitted as its function can be subsumed by AggregateVerify, allowing verification of individual signatures during the verification of the aggregated signature, or alternatively, in the verification phase, only the validity of the aggregated signature may be checked as the aggregated signature may be valid if and only if each individual signature is valid.

Aggregate and AggregateVerify algorithms provide the necessary grounds for compressing digital information without sacrificing its integrity. AggregateVerify enables the aggregated signature to be verified and confirms the ability of aggregate signatures to store compressed transaction information on the blockchain. Indeed, AggregateVerify, which is used as a verification function, ensures that aggregate signatures are correct, and they can be used to verify that the set of transactions on a blockchain represents the true set of valid transactions submitted as input. Executing AggregateVerify on an aggregate signature thus allows a blockchain to verify the resulting aggregate signature before recording it on-chain.

The actual size of aggregated signatures A may vary depending on different scenarios and factors. It is influenced by the specific signature aggregation technique used, the number of signatures being aggregated, the signature scheme itself, and any additional metadata or overhead included in the aggregation process.

In certain scenarios, the signature aggregation scheme may involve a straightforward concatenating process, where the size of the aggregate signature A formed by aggregating N individual signatures (s₁, . . . , s_{N}) is equal to N times the size of an individual signature s, making |A|=|O(N)|=N*|s|. This mode of linear aggregation is, without loss of generality, possible with any signature scheme.

However, in other cases, the aggregated signatures may be more compact, resulting in sublinear size with respect to N. For instance, the size of the aggregate signature may scale logarithmically with N(|A|=|O(ln(N))|). In such cases, the aggregated signature becomes more efficient to publish than the N individual signatures in an asymptotic sense. This means that as the number of signatures N increases, the size of the aggregated signature grows more slowly than the linear increase seen when concatenating signatures individually. There is a space-saving effect. Due to the constant factor involved in the asymptotic notation, there exists a threshold concerning the number of signatures N below which no compression or compactness effect is evident. This threshold is determined by the logarithmic scaling. For instance, if the size of the aggregate signature is given by |A|=C1 ln(N), where C1≈20*|s|, a space-saving effect will only be noticeable for values of N above 90. Furthermore, the threshold is influenced by any additional data that may be included in the aggregated signature during the aggregation process. As the size of this additional data increases, the threshold will also increase, meaning a higher number of signatures will be needed to observe significant space-saving benefits. The additional data contributes to the overall size of the aggregated signature and affects the point at which the compactness effect becomes apparent.

In certain protocols, the public keys (pk₁, . . . , pk_{N}) may be published alongside the aggregated signatures. In such embodiments, assuming a logarithm scaling, space savings may be observed when the number of signatures N satisfies the following conditions: N|pk|+C1 ln(N)+C2<N(|pk|+|s|), where C2 is a constant, and |pk| the size of an individual public key. This expression represents the trade-off between the size of the aggregated signature and the space required for publishing the public keys.

The space-saving in aggregated signatures may be achieved by employing composite expressions, which refer to structured and/or condensed representations of the individual signatures employing various mathematical objects or models. For example, a composite expression may correspond to a mathematical construction derived from the individual signatures s, their components, or other associated data (e.g., public keys, messages . . . ) involving various cryptographic functions such as hash functions, random oracles (idealized hash functions) or bilinear pairings. The space-saving (size of aggregated signatures A) may be therefore based on the composite expressions selected. For example, an illustrative use case may involve summing all the signatures and storing the sum as an aggregated signature instead of storing each individual signature separately. If each signature can be represented as a K-bit number, the maximum value of the sum of N K-bit numbers would be N*2^{K}. Using binary logarithm notation, the maximum number of bits required to represent such a sum would be floor(ln₂ (N*2^{K}))+1, resulting in the size of the aggregated signature scaling logarithmically with N (|A|=|O(ln(N))|). Another example that exhibits similar scaling could involve the utilization of a linear combination (rather than a simple sum) where the coefficients are derived from a random oracle. This random oracle is queried on all signatures that are aggregated, and the resulting coefficients are used to compute the linear combination.

It should be noted that the space-saving associated with aggregated signatures does not result from any compression techniques. Compression techniques are designed to transform data into a more compact form that can be recovered, or uncompressed, for later use. However, for aggregated signatures, the non-aggregated signatures cannot be recovered from the aggregate signature, in contrast with a compression technique. Instead, the space-saving in aggregated signatures is achieved through other means, such as employing composites expression and mathematical relationships to efficiently verify the validity of multiple signatures without storing them individually.

As with a non-aggregated signature, an aggregated signature A may also consist of multiple components represented by A=(a₁, . . . , a_{M′}). The total number of aggregated signature components is denoted by M′, and these components may be portions of composite expressions, and may be related to each other through various mathematical relationships.

In most scenarios, aggregate signature schemes preserve security levels within the system. Despite aggregating multiple signatures, the security strength is maintained as the aggregate signature's security level is determined by the weakest link among the individual signatures, as well as by the security of the aggregation algorithm itself.

In accordance with some embodiments, the aggregate signature A may also be generated using a zero-knowledge proof algorithm. For instance, in accordance with an embodiment, an aggregator (prover) may want to prove to have knowledge of a set of N signatures (s₁, . . . , s_{N}) (private witness), and of a function F((μᵢ,pkᵢ, sᵢ)_{i=1:N})=A, without revealing either information. To achieve this, the aggregator may employ zk-SNARK to encode all the relevant information required to validate the individual, non-aggregated signatures into several high-degree polynomials over a finite field, which comprises more elements than the highest degree of these polynomials. For example, the aggregator may compute interpolated polynomials that provide all the signatures being aggregated when evaluated on a subset of the underlying field, along with additional interpolated polynomials that evaluate all the corresponding public keys. Subsequently, the aggregator uses the set (μᵢ,pkᵢ)_{i=1:N} to create unpredictable challenges and generates the proof. In embodiments employing Post-Quantum Cryptography (PQC) in a digital signature scheme, the use of quantum-resistant or post-quantum Zero-Knowledge Proof (ZKP) algorithms may be employed to ensure the security and resistance against potential attacks from quantum computers. One of the examples of such a post-quantum ZKP algorithm is the Aurora algorithm. As for an individual signature, the ZKP proof may be integrated as one of the components of the aggregated signature A and contribute to the overall size of the signature or represent the signature itself A. The size of the aggregated signature, when generated using a ZKP algorithm, depends on the specific proving system that is selected. Not all proving systems will produce the smallest proof size for all types of statements. Therefore, certain proving systems may be more suitable for the aggregation process, as they can offer more efficient and compact proofs in certain scenarios.

Further advantages may be associated with use of Zero-Knowledge Proof (ZKP) techniques in formulating aggregate signature schemes. In the above exemplary embodiment, the aggregator (prover) refrains from disclosing individual signatures to the verifier. Consequently, these signatures may be entirely omitted from the resultant aggregate signature, yielding significant space savings.

In some embodiments, a non-zero-knowledge proving system may be employed. Whilst this approach might, in some circumstances, expose certain non-zero information pertaining to the private witnesses (in this context, the individual signatures), this may be acceptable within the framework of an aggregate signature scheme, since in many applications, digital signatures may not encompass any private or sensitive information.

### 4. Exemplary Embodiments

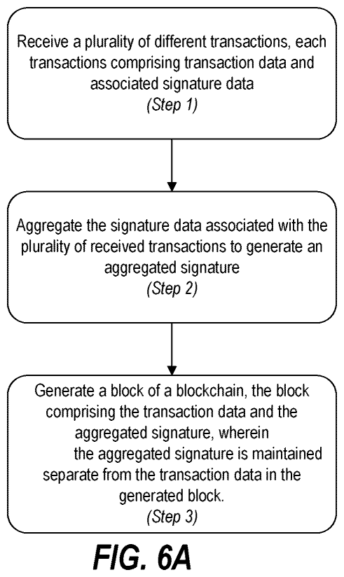

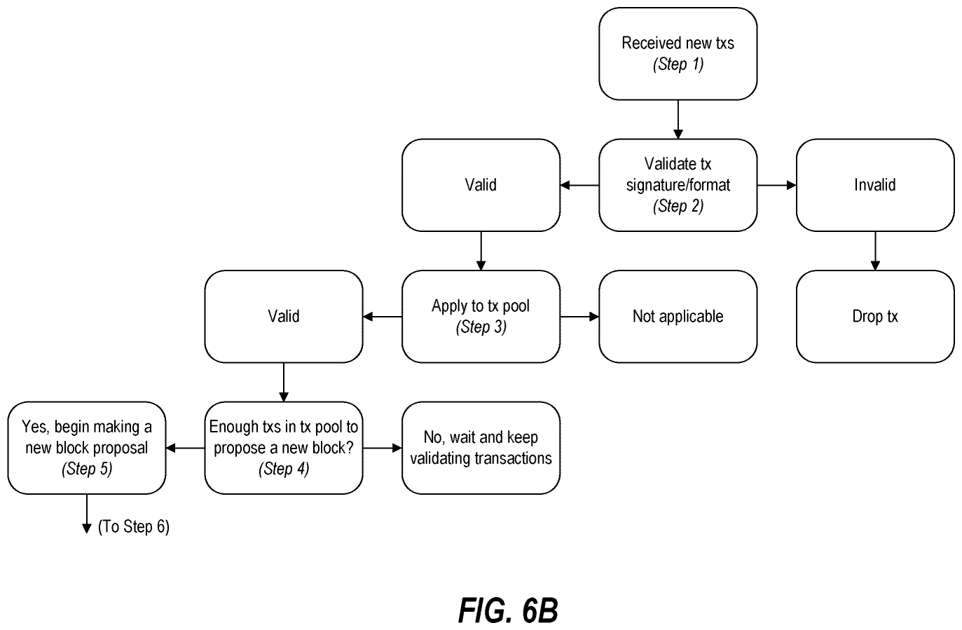

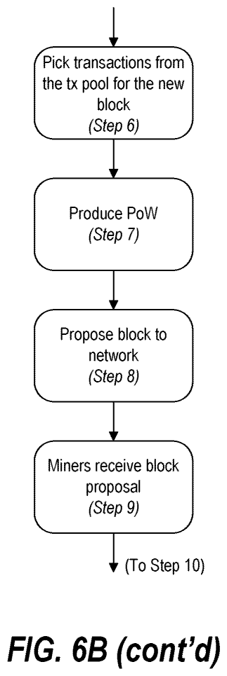

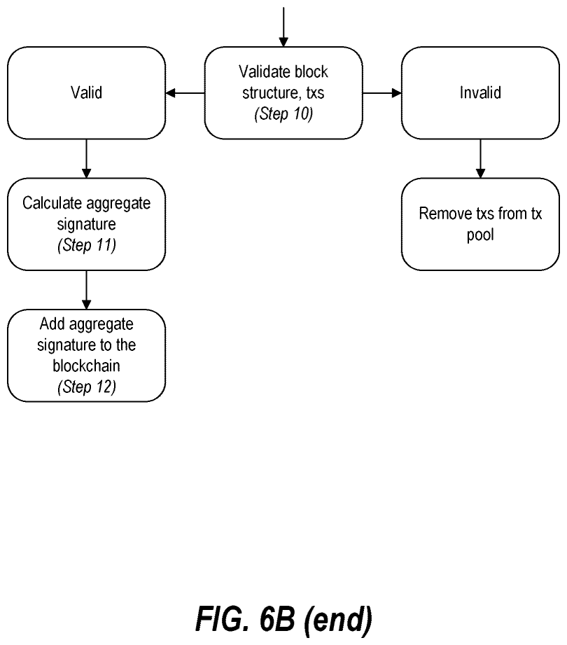

FIG. 6A illustrates the steps comprised in an exemplary process for aggregating signatures in a blockchain from a plurality of different transactions, in accordance with an embodiment. The illustrated process steps in FIG. 6A may be performed by at least one miner server 15 of a blockchain network 5, illustrated in FIG. 1. Miner server 15 receives a plurality of different transactions Txs, each transaction comprising transaction data and its associated signature data s, in step 1. For example, the plurality of transactions may correspond to a plurality of transactions selected from transaction pool 3 of FIG. 1. In some embodiments, each transaction may be associated with a distinct public-private key pair (pkᵢ, skᵢ), selected using a digital signature scheme (e.g., KeyGen, Sign, Verify). The signature data sᵢ associated with a transaction may be generated by encrypting the transaction data Tₓᵢ with the private key skᵢ associated with that transaction. Additionally, in some further embodiments, each signature data sᵢ may include a plurality of different signature components sᵢ=(s_{i,1}, . . . , s_{i,M}).

In some embodiments, the signatures sᵢ associated with the plurality of different transactions Txs are multi-use signatures. Furthermore, in some other embodiments, the signature data sᵢ and the corresponding public pkᵢ and secret key skᵢ pair may be generated using a post-quantum cryptography digital signature scheme. By using post-quantum cryptography for signature generation, the blockchain network may enhance its security and future-proof the system against potential threats posed by quantum computing advancements. More specifically, in some embodiments, the post-quantum cryptography digital signature scheme is a lattice-based cryptography digital signature scheme. Examples of lattice-based cryptography digital signature schemes include Falcon, Dilithium qTESLA, Rainbow, and Bliss digital signature schemes. In yet further embodiments, the lattice-based cryptography digital signature scheme is a Hash-and-Sign signature. Falcon signature scheme is an example of Hash-and-Sign lattice-based signature.

Once the plurality of transactions are received, the server miner 15 aggregates the signature data sᵢ associated with these transactions to generate an aggregated signature A, in step 2. This aggregation process may comprise using an aggregated signature algorithm (e.g., Aggregate) comprising a set of transaction-key-signature triples (Tx₁, pk₁, s₁), . . . , (Tx_{N}, pk_{N}, s_{N}). In certain embodiments, the at least one miner server 15 may act as an aggregator, meaning that the miner 15 generates the aggregated signature and carries out the necessary computations to achieve this. Alternatively, the generation of the aggregated signature may be carried out by an external aggregator off-chain. This external aggregator may not be trusted and might not need to interact with on-chain parties other than the at least one miner server 15. Consequently, aggregating the signature data may involve sending the plurality of different transactions to an external aggregator, configured to generate an aggregated signature, and receiving the generated aggregated signature from the external aggregator.

In some embodiments, when the plurality of different transactions includes a number N of transactions, the size of the aggregated signatures A may be smaller than the combined size of all the N individual signatures associated with the plurality of different transactions (sᵢ)_{i=1:N}. Alternatively, the number N of transactions may be greater than a threshold number of signatures Nth below which no compression or compactness effect is evident. Indeed, in some embodiments, the size of the aggregated signature A may be sublinear in size with respect to N. For example, in some embodiments, the size of the aggregate signatures A may scale logarithmically with N (|A|=|O(ln(N))|). When the number N of transactions exceeds this threshold (Nth), the aggregated signature becomes increasingly advantageous in terms of space efficiency, as its size grows at a slower rate compared to the cumulative size of individual signatures for each transaction.

In some embodiments, the aggregate signatures A may be generated using a zero-knowledge proof algorithm or a post-quantum zero-knowledge proof algorithm. Examples of post-quantum zero-knowledge proof algorithms may include the Aurora algorithm.

In some embodiments, the aggregated signature A may include a plurality of aggregated signature components A=(a₁, . . . , a_{M′}) where M′ denotes the total number of aggregated signature components. These components may be portions of composite expressions, composite expressions, outputs of a cryptographically verifiable computing algorithm, or a combination thereof. Examples of cryptographically verifiable computing algorithms may include a zero-knowledge proof algorithm (e.g., Aurora algorithm, Plonky 2, zk-STARK) or a probabilistic checkable proof. Alternatively, in some other embodiments, the aggregate signature A may include a single component, which may be a composite expression or an output of a cryptographically verifiable computing algorithm.

Finally, in step 3 of FIG. 6A, miner server 15 generates a block of the blockchain. This block comprises the transaction data and the aggregated signature, where the aggregated signature is maintained separate from the transaction data within the generated block. In some embodiments, the block may have been previously generated; thus, generating the block of the blockchain may involve updating an existing block by replacing all the individual signatures s with the aggregated signature A. In some embodiments, the block may be entirely new, so generating the block of the blockchain may involve creating a new block that directly includes the aggregated signature.

### 4a Post-Quantum Signature Aggregation Using Hash-and-Sign Latticed-Based Signature Scheme (e.g., Falcon Signature)

In accordance with some embodiments, which are quantum resistant, a quantum-resistant signature scheme may be chosen. For example, the chosen signature scheme may relate to a lattice cryptography scheme or any other quantum-resistant lattice cryptographic scheme. The aggregate signature may then be generated using the mathematical properties of lattice-based public-key cryptography. The following section of the description elaborates on the procedure illustrated in FIG. 6A, in particular when applied to signatures produced using the Falcon signature scheme. Nevertheless, it is important to appreciate that the described method may be adapted to encompass various types of Hash-and-Sign lattice-based signature schemes. The common feature shared between these different schemes is the verification algorithm, which encompasses the validation of whether specific vectors exhibit a short characteristic within a lattice.

The Falcon signature scheme consists of three stages:
(1) a key generation (Key_{FALCON}) outputs public key pk and secret key sk;
(2) a signing function (Sign_{FALCON}) takes sk and a message, such as transaction data Tₓ and outputs the signature s=(s₁, s₂), with two signature components (polynomials) s₁ and s₂. Here, s₂ represents the actual signature generated using the secret key sk, and s₁ is related to s₂ by the following relation s₁=hash(Tₓ)−s₂*pk mod Φ mod p, with hash( ) a hash function outputting an element in a polynomial ring, where Tₓ is the transaction data, pk the public key corresponding to the secret key sk, Φ a monic polynomial, and p a prime number;
(3) a verifying function (Verify_{FALCON}) takes pk, s, Tₓ and outputs the validity (true or false) of the signature by checking s₁+s₂·pk=hash(Tₓ) and the ∥s∥ is below some bound (appropriately short vector). The product s₂·pk refers to polynomial multiplication. Note that all the elements are usually in a polynomial ring (mathematical structure), and the hash function outputs an element over the polynomial ring. For example, the Falcon signature is one of the lattice-based signature schemes in this form.

Stage (1) enables the creation of asymmetric key pairs used to provide secure, private transaction broadcasting in a blockchain environment. Private keys provide access to, for example, a user account's available funds ensuring that only those with the private key are able to access the available funds in the account. Public keys are used to attest to the ownership of funds when making a transaction with those funds in a way that is publicly verifiable by the rest of the network participants.

Stage (2) enables payors to attest to owning the funds involved in a transaction. When a transaction is made, the payor signs the transaction with their private key. The resulting output is a digital signature which allows the payee to verify the identity of the payor.

Stage (3) is the process by which a payee can verify a payor's attestation of owning the funds involved in a transaction. The payee decrypts the signed message from stage (2) using the payor's corresponding public key (pk) in order to verify the identity of the payor.

Given a set of transaction data (i.e. messages), signatures and their corresponding public keys, {(Tₓᵢ, sᵢ, pkᵢ)}_{i=1 to k}, then the method for aggregating the signatures sᵢ for all i is as follows:

First, k random values r₁, . . . , rₖ=Hash₂({pkᵢ, Tₓᵢ}, pp, β) are calculated, where pp is some public parameter and Hash₂ is a hash function that outputs some values which are smaller than some bound β. β is a predetermined value with a format defined in the selected signature scheme and whose value is provided by the output of the Hash₂ algorithm. In other words, for each transaction Tₓᵢ a value rᵢ is calculated in accordance with the above equation. Parameters pp and β are included to improve security. Their values may be dependent on the selected signature scheme. For example, where the Falcon signature scheme is used, the value of β may be determined in accordance with equation 2.15 in the document entitled “FALCON: Fast Fourier Transform Lattice-based Compact Signature over NTRU” specification 1.2, by Fouque et al., and available at the following address https://falcon-sign.info/falcon.pdf. Accordingly, in some embodiments, they may be omitted altogether, in which case r₁, . . . , rₖ=Hash₂ (pkᵢ, Tₓᵢ). Any cryptographic hash function may be used. Once values rᵢ have been determined, then the signatures sᵢ may be aggregated.

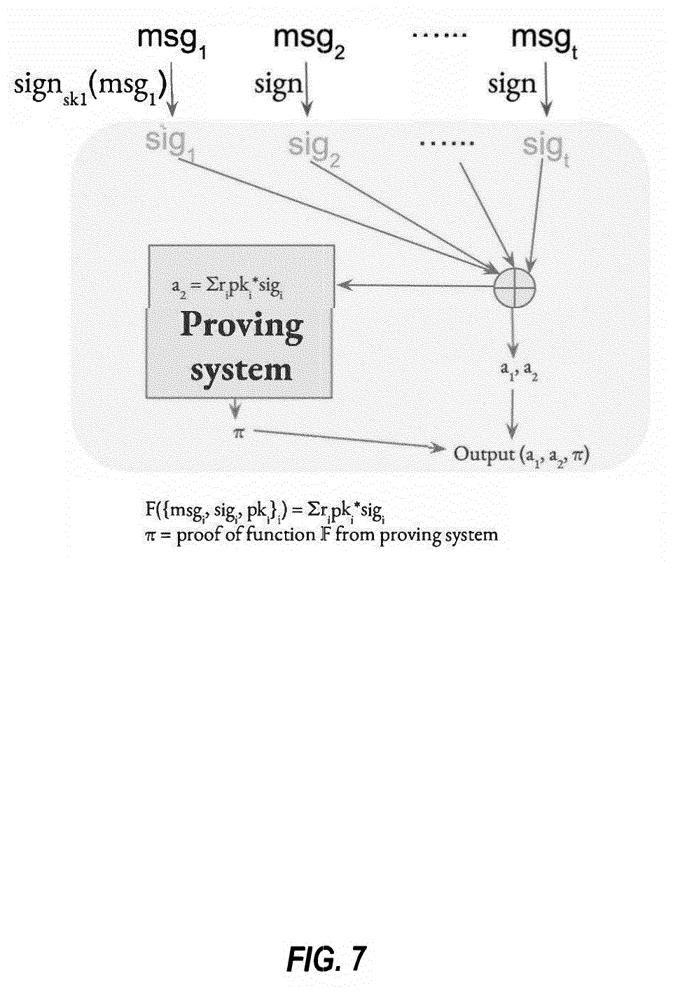

(Process 1) The process to aggregate an aggregate signature is given in FIG. 7. The Aggregate Signature comprises three components a₁, a₂, π, and is defined as A=(a₁, a₂, π). Components a₁ and a₂ are calculated using the following equations a₁=Σrᵢ*s_{i,1}, a₂=Σrᵢ*pkᵢ*s_{i,2}, π, the third component of the aggregate signature A, may be calculated using a Zero-Knowledge Proof algorithm, from knowledge of component signature a₂. This also confirms that a₂ is generated correctly. One example of a Zero-Knowledge Proof algorithm that may be used is the Aurora algorithm, which has the added benefit of being quantum-secure. Further details of the Aurora algorithm may be found at https://eprint.iacr.org/2018/828.pdf. It is however to be appreciated that any Zero-Knowledge Proof algorithm, including but not limited to a recursive Zero-Knowledge Proof algorithm, may be used, although if it is desired that the method is also quantum-secure, then a quantum-secure Zero Knowledge Proof algorithm is required.

For a given message Tₓᵢ, signature sᵢ, and public key pkᵢ there exists a function F( ) such that F({Tₓᵢ, sᵢ, pkᵢ}ᵢ)=Σrᵢ*pkᵢ*sᵢ.=a₂. The Zero-Knowledge Proof algorithm thus is able to prove function F( ) provided with information a₂, transaction Tₓᵢ, signature sᵢ, public key pkᵢ, and wherefrom the third aggregated signature component π is determined. This process is illustrated in FIG. 7.

Alternatively, in some embodiments, the process to aggregate an aggregate signature may only comprise generating a proof using a Zero-knowledge proof algorithm. In such embodiments, use of the composite expressions a₁ and a₂ is not necessary, and the aggregated signature A may uniquely be represented by the proof π, as this latter plays a more valuable role in the verification process of the aggregated signature. In other words, the aggregation mechanism is not dependent on specific composite expressions for the aggregated signature, but instead relies on the Zero-knowledge proof to create the aggregate signature. However, this process may still require the generation of a private witness, or of at least one component of the private witness by using composite expressions. An example of such a process is presented below:

(Process 2)

```
1. For i-th signature (s_{1,i}, s_{2,i}) and corresponding public key and message (pkᵢ, mᵢ)
2. compute Hash(mᵢ)
3. compute qᵢ s.t. Hash(mᵢ) − pkᵢ s_{2,i} + qᵢ p in [-(p-1)/2, (p-1)/2]
4. compute s_{1,i} = Hash(mᵢ) − pkᵢ s_{2,i} + qᵢ p
5. run zk proving system for the following arithmetic relation with
    private witness ({s_{1,i} , s_{2,i}, qᵢ}_{i=1 to N}) and public instance ({pkᵢ, Hash(mᵢ)}_{i=1 to N})
  1. range check for all coefficients in s_{2,i}, i.e. s_{2,i} in [-(p-1)/2, (p-1)/2], for i in [N]
  2. equality check for s_{1,i} = Hash(mᵢ) − pkᵢ s_{2,i} + qᵢ p, for i in [N]
  3. range check for all coefficients in qᵢ, i.e. qᵢ in [-(p-1)/2, (p-1)/2], for i in [N]
  4. range check ||s_{1,i}||² + ||s_{2,i}||² < β², for i in [N]
6. output aggregated signature π which is the proof output by ZK proving system.
```

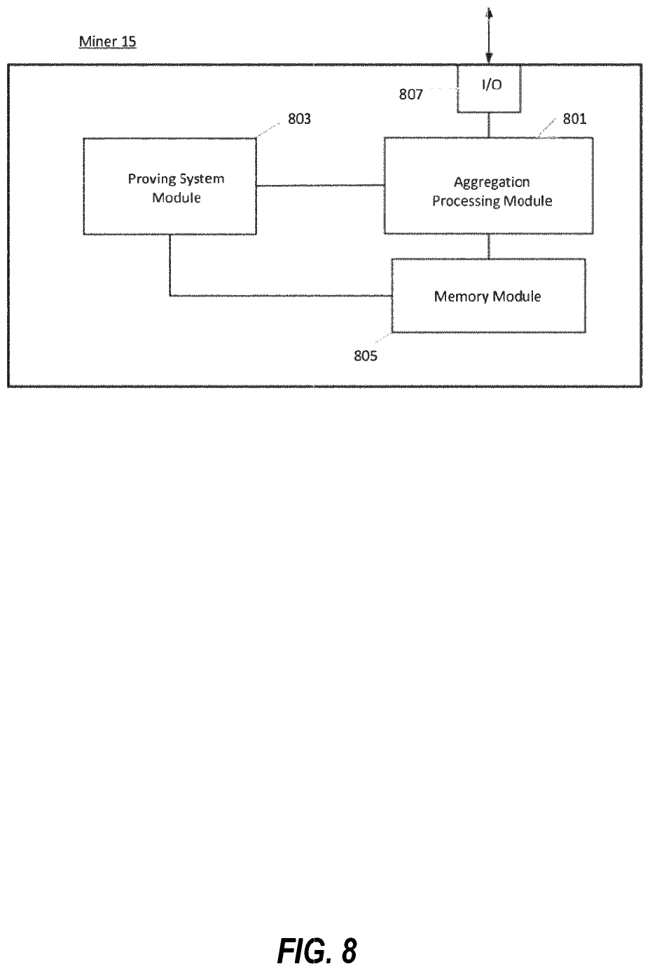

To implement the aforementioned methods, miner 15 may comprise an aggregation processing module 801, a proving system module 803, and a memory module 805, as illustrated in FIG. 8. Data received via Input/Output module 807, such as transaction data Tₓᵢ, signatures sᵢ, public keys pkᵢ, may be processed by the aggregation processing module 801. For example, aggregation module 801 implementing process 1 may be configured to generate values rᵢ and subsequently aggregated signature components a₁ and a₂. Alternatively, when implementing process 2, aggregation module 801 may be configured to compute values qᵢ and s_{1,i} of the private witness. In other words, the aggregation processing module 801 may calculate aggregate signature components or a portion of the private witness used to run a zero-knowledge proof-algorithm. Proving system module 803 may be configured to generate the third aggregated signature component π (process 1), as described above, by employing a Zero-Knowledge Proof algorithm, or directly calculating the aggregated signature represented by π (process 2). To achieve this, proving system module 803 may be provided with aggregated signature component a₂, or with the private witness ({s_{1,i}, s_{2,i}, qᵢ}_{i=0 to T}) calculated by aggregation processing module 801. Aggregated signature components a₁, a₂, π, which define the aggregated signature A, may be stored in memory module 805 for subsequent addition to a blockchain block, as illustrated in FIG. 5.

Note that, miner 15 which has the set of messages, signatures and public keys may execute the aggregate signature algorithm described in Process 1 or 2 and outputs valid results. Miner 15 thus processes a set of messages, signatures and public keys, and outputs the components required to define a single aggregate signature A mathematically describing the contents of the aggregated set. The aggregate signature reduces the spatial overhead of storing N messages on a blockchain as long as the size of the aggregate signature is less than N times the length of the individual non-aggregated signatures, which is true in this case for a given number of messages N. Due to the fact that both composite expressions a1 and a2, as well as the proof π scale sub-linearly with N (e.g., logarithmically) a threshold number of signatures exists below which no significant space-saving effect is observed. In the specific case of the Falcon signature, this threshold number is approximately equal to 150 signatures.

This advantage is compounded when applied to post-quantum cryptographic signatures, where the lengths of these signatures are invariably longer than non-quantum resistant signatures. The herein disclosed signature aggregation method thus provides a space-efficient way to store post-quantum signatures in any finite memory space. This holds especially true for storing transaction signatures in a blockchain environment. In such an application, messages represent transactions Tₓᵢ (as described in Section 3a) which are signed by and associated with a public key pkᵢ. When transactions are submitted to the blockchain they are broadcasted to a network of blockchain miners responsible for constructing the next block of transactions. Since any blockchain miner who has the set of transactions, signatures and public keys can generate the aggregate signature and output a valid aggregate signature A, any blockchain miner server 15 in the network may propose the next block containing the space-efficient aggregate signature A.

Similarly, any authorised user 7, 9, 11, or 13 may validate a transaction on the blockchain by verifying the validity of the associated aggregated signature. This is described further below. In contrast to conventional blockchain signature verification schemes where the signature associated with a specific transaction is verified, the herein-disclosed aggregated signature method requires that the aggregated signature is verified for an associated transaction on the blockchain. Verification of transactions is typically carried out by a verification entity which may relate to any one of users 7, 9, 11, 13 of FIG. 1. It is however to be appreciated that any entity having a genuine need to verify a transaction on the blockchain may verify the aggregated signature. The verification process is not exclusive to users 7, 9, 11, 13.

(Algorithm 1) The verification algorithm to check the aggregated
signature corresponding to Process 1 is as follows:

```
(1) a₁ + a₂ = Σrᵢ*hash(Tₓᵢ) //Since we have rᵢ* (s_{i,1} + pkᵢ*s_{i,2})= rᵢ*hash(Tₓᵢ)
(2) ||a₁|| is below to a specific bound β //since rᵢ are small and sᵢ is small
(3) The correctness of the proof of a₂ is generated, including a₂ = rᵢ* pkᵢ*s_{i,2} with ||s_{i,2}|| are
  below to a specific bound β for all i. β is dependent on the selected signature scheme. For
  example, for the Falcon signature scheme, β may be determined in accordance with
  equation 2.15 outlined in the document https://falcon-sign.info/falcon.pdf.
```

It is to be appreciated that the verifier, who may be any one of users 7, 9, 11, 13 of FIG. 1, has possession of the transaction data Tₓᵢ, associated public key pₖᵢ, and aggregate signature A=(a₁, a₂, π), and wishes to determine that the aggregate signature A is valid for the given transaction data Tₓᵢ. The verifier is able to calculate the sum of the first and second aggregate signature components a₁ and a₂ using the above algorithm in combination with knowledge of the transaction data Tₓᵢ, parameters rᵢ and the hash function associated with the employed key signature protocol. Regarding process 2, the verification algorithm (Algorithm 2) focuses solely on verifying the proof generated by the Zero-knowledge proving system, as this proof fully represents the aggregated signature.

In practice, the size of the aggregate signature for 1024 signatures of Falcon is 117 KB, which is 16% of the original size of all 1024 Falcon signatures. Moreover, as an aggregate signature is produced using a zero-knowledge proving system, it is possible to reduce the size of aggregate signatures further with a better proving system. The verification function provides the necessary security behind the aggregate function. Since the miner outputs a single aggregate signature describing the contents of the aggregated set, a method to verify the correctness of the aggregate signature is required. As shown in FIG. 7, a₂ is generated by a proving system module 803 which is constructed using only the real inputs of the aggregated set. In order to prove that the output aggregate signature reflects the correct input set, the correctness proof of a₂ must be generated which is only possible if the aggregate signature contains the correct a₂. Taken together, Equation 1 and Algorithm 1 provide the necessary grounds for compressing digital information without sacrificing information. Algorithm 1 enables the aggregated signature to be verified and confirms the ability of aggregate signatures to store compressed transaction information on the blockchain. Indeed, Algorithm 1 which is used as a verification function ensures that aggregate signatures are correct and they can be used to verify that the set of transactions on a blockchain represents the true set of transactions submitted as input. Executing Algorithm 1 as a verification function on an aggregate signature thus allows a blockchain to verify the resulting aggregate signature before recording the aggregate signature on-chain where it will live forever.

### 5. Execution on Physical Devices

Implementation, in a computerised network such as illustrated in FIG. 1, of the herein-described methods of aggregating signatures (Equation 1) and method of verifying signatures (Algorithm 1), requires a slight modification to a typical blockchain network, in two ways:
1. Private-public key pair issuance
2. Transaction processing

### 1. Private-Public Key Pair Issuance

When a user, such as a user on a user terminal 7, 9, 11, 13 of FIG. 1, creates a new account on the computerised network 1, a private-public key pair is issued to them. In accordance with some embodiments, and in particular where quantum resistance is desired, instead of generating the key pair using an elliptic curve (as is done in typical blockchains e.g. Bitcoin blockchain), key pairs are generated from a post-quantum digital signature algorithm, for example, based on a lattice, such as the Falcon signature protocol. This ensures the key pair is quantum-resistant, meaning it is not susceptible to attack from a quantum computer.

### 2. Transaction Processing Using Zero-Knowledge Proofs (ZKP)

In a typical blockchain, when users send transactions to the network each transaction is processed independently. Each transaction contains its own header, data and digital signature and is sequentially added into the block. In accordance with embodiments of the disclosure, instead of individual transactions being processed individually, digital signatures from multiple transactions are aggregated into a single signature. This aggregation may take place on, for example, blockchain miner server 15. In accordance with some embodiments, blockchain miner server 15 may process transactions in exchange for some native currency provided as a reward. Blockchain miner server 15 is responsible for implementing the signature aggregation algorithm and submitting a new block containing the aggregate signature. A Zero-Knowledge Proof algorithm is used to generate at least one of the components of the aggregated signature. The aggregate signature can then be verified using the verification algorithm described in Algorithm 1. Verification of the aggregate signature may be carried out by any user on user terminal 7, 9, 11, or 13 of FIG. 1.

FIG. 6B illustrates how a blockchain miner server 15 of FIG. 1 interacts with user transactions to aggregate multiple transactions. Miner server 15 of FIG. 1 receives new transactions from communication network 5 of FIG. 1 sent by a user, such as a user on user terminal 7, 9, 11, 13 of FIG. 1, as detailed in step 1 of FIG. 6B. Miner server 15 proceeds to validate the incoming transactions based on their digital signatures and format in step 2. Once transactions have been validated, they are sent back to communication network 5 and stored in the transaction pool 3 of FIG. 1, as detailed in step 3 of FIG. 6B. The validation process may include several steps. For example the miner 15 may check the transaction format to ensure it contains all the necessary information (sender/receiver addresses, transaction amount, structure of the transactions header . . . ), verify that the sender possesses sufficient funds to carry out the transaction, as their balance must be equal to or greater than the transaction amount, and/or prevent double-spending by ensuring that the same funds have not been utilized in another transaction. Additionally, the authenticity and integrity of the signature associated with a transaction may be further verified. This subprocess may include obtaining the public key pk of the user (signer), retrieving the signature data s from the transaction Tx, running the verification algorithm Verify (pk, Tx, σ) using the public key and the signature data, and confirming that the transaction was indeed signed by the holder of the private key sk associated with the public key pk used in the signature σ via the output b of the verification algorithm. Miner server 15 of FIG. 1 continues to add to the transaction pool 3 of FIG. 1 until communication network 5 alerts the miner server 15 that there are enough transactions in transaction pool 3 to propose a new blockchain block, as detailed in steps 4 and 5 of FIG. 6B. Once miner server 15 is ready to propose a new block, transactions from transaction pool 3 are collected to form the new block, as detailed in step 6 of FIG. 6B. Miner server 15 proceeds to generate a cryptographic proof (e.g., proof-of-work) to prove to communication network 5 that a certain amount of computational effort has been expended with the collected transactions for the new block proposal as detailed in step 7 of FIG. 6B. Once the proof-of-work of step 7 is complete, miner server 15 proposes the new block to the network, as outlined in sep 8. After a new block has been proposed to communication network 5, miner server 15 is notified of the new block proposal, as detailed in step 9 of FIG. 6B. Miner server 15 then attempts to validate the block, as detailed in step 10 of FIG. 6B. To be considered valid, a newly proposed block may include a correct aggregate signature for all the transactions in a previous block, and a correct hash of a previous block, ensuring that transactions data are immutable. Once the block has been validated, miner server 15 may calculate the aggregate signature, as detailed in step 11 of FIG. 6B. After the aggregate signature has been calculated, it is added to the blockchain, as detailed in step 12.

While the aforementioned embodiments have been described within the context of a single miner 15, it is important to appreciate that network 5 may comprise multiple miners. Additionally, certain steps of the method illustrated in FIG. 6B may be carried out by different miners. For instance, the validation of the block, at step 10, may involve a consensus algorithm that engages several or all miners within the network. Similarly, it is important to appreciate that the miner proposing the block may not necessarily be the same miner responsible for generating the aggregated signature.

In embodiments where the aggregated signature is incorporated into a block after validation, the block is mutable, i.e., the contents of the block can be modified after its creation. However, in other embodiments, blocks may be immutable, i.e., once a block is created and added to the blockchain, its contents cannot be altered. In such embodiments, the step of signature aggregation (step 11 of FIG. 6B) may be performed simultaneously with the new block generation (step 6 of FIG. 6B). Digital signatures are aggregated and the aggregated signature is incorporated into the block before it is added to the blockchain.

Once the aggregated signature is generated, the above-described methods may also encompass an aggregated signature verification step. This involves executing an aggregated signature verification algorithm (e.g., AggregateVerify) utilizing the aggregated signature along with the set of transactions and their corresponding public keys (Txᵢ,pkᵢ)_{i=1:N}. The verification ensures the authenticity and integrity of the aggregated signature and its association with the transactions. This verification step may be performed by any node within the blockchain network 5. The decentralized nature of blockchain networks allows multiple nodes to independently verify the aggregated signature, promoting trust and consensus in the validation process.

In some embodiments, the verification of the aggregated signature may inherently include the verification of all the individual signatures that make up the aggregate. Due to this “batch verification” capability, it may not be mandatory to verify each individual signature separately at step 2 of FIG. 6B as verifying individual signatures before the aggregation step could lead to redundancy (the same signatures would be verified again during the aggregated signature verification). By employing batch verification with the aggregated signature, the verification process may become more efficient and reduce computational overhead. The aggregated signature provides a compact representation of the individual signatures, and its verification encompasses the validation of all included signatures in a single step.

Whereas in the preceding embodiments of the disclosure the proving system module 803 is disclosed as applying a zero-knowledge proof algorithm to determine the third aggregated signature component x or directly the aggregated signature, in alternative embodiments it is to be appreciated that any cryptographically verifiable computing algorithm, such as probabilistic proof algorithms, or either zero-knowledge or non-zero-knowledge proof algorithms may be used since the transaction data may be public. In other words, where the transaction data is public zero-knowledge is not essential, and therefore other cryptographically verifiable computing algorithms may also be used.

In embodiments wherein the signature aggregation may be performed out-chain Input/Output module 807 may be configured to send transaction data Tx, signatures s, and public keys pk, to an external aggregator (not illustrated) and collect the aggregated signature generated by the external aggregator.

The foregoing description has been presented for purposes of illustration. It is not exhaustive and is not limited to precise forms or embodiments disclosed. Modifications and adaptations of the embodiments will be apparent from consideration of the specification and practice of the disclosed embodiments. For example, the described functional modules of the miner may be implemented with hardware and/or software. In addition, while certain components have been described as being coupled to one another, such components may be integrated with one another or distributed in any suitable fashion.

Moreover, while illustrative embodiments have been described herein, the scope includes any and all embodiments having equivalent elements, modifications, omissions, combinations (e.g., of aspects across various embodiments), adaptations and/or alterations based on the present disclosure. The elements in the claims are to be interpreted broadly based on the language employed in the claims and not limited to examples described in the present specification, which examples are to be construed as nonexclusive.

Other embodiments will be apparent from consideration of the specification and practice of the embodiments disclosed herein. It is intended that the specification and examples be considered as example only, with a true scope and spirit of the disclosed embodiments being indicated by the following claims.

1. A method of aggregating a plurality of signatures together, each signature being associated with a different transaction, into a block of a blockchain, the method comprising:
receiving a plurality of different transactions, each transaction comprising transaction data and associated signature data;
aggregating the signature data associated with the plurality of received transactions to generate an aggregated signature;
generating a block of a blockchain, the block comprising the transaction data; and wherein the aggregated signature is maintained separate from the transaction data in the generated block.

2. The method of claim 1, wherein each transaction is associated with a public key, pki, and private key, ski, pair, the public and private key pair being selected using a digital signature scheme, and the signature data, si, associated with a transaction is generated by encrypting the transaction data, Txi, associated with the transaction, with the private key, ski, associated with the transaction.

3. The method of claim 2, wherein aggregating the signature data associated with the plurality of received transactions to generate the aggregated signature comprises using an aggregation algorithm in combination with the public key, pki, and the signature data, si, associated with each transaction and the plurality of transaction data, to generate the aggregated signature.

4. The method of claim 2, wherein aggregating the signature data associated with the plurality of received transactions to generate the aggregated signature, comprises:
sending the public key, pki, the signature data, si, and the transaction data associated with the plurality of transactions, to an aggregator configured to generate the aggregated signature using an aggregation algorithm; and
receiving the generated aggregated signature.

5. The method of claim 2, wherein the digital signature scheme is a multi-use signature scheme.

6. The method of claim 2, wherein the digital signature scheme is a post-quantum digital signature scheme.

7. The method of claim 6, wherein the post-quantum digital signature scheme is a lattice-based cryptographic digital signature scheme.

8. The method of claim 7, wherein the lattice-based cryptographic digital signature scheme is a hash-and-sign lattice-based cryptographic digital signature scheme.

9. The method of claim 8, wherein the hash-and-sign lattice-based cryptographic signature scheme is the Falcon signature scheme.

10. The method of claim 1, wherein the aggregated signature comprises a plurality of aggregated signature components.

11. The method of claim 10, wherein the plurality of aggregated signature components comprise any one or more of: at least a portion of a composite expression, a composite expression, one or more outputs of a cryptographically-verifiable computing algorithm.

12. The method of claim 11, wherein the cryptographically verifiable computing algorithm comprises any one of:
a) a probabilistic checkable proof;
b) a zero-knowledge proof algorithm.

13. The method of claim 8, wherein aggregating the signature data associated with the plurality of received transactions to generate the aggregated signature, comprises:
determining, at least one composite expression for the received plurality of transactions based on any one or more of: the public key, pki associated with the transaction, the transaction data, Txi associated with the transaction, at least one hash function; and
determining, using the at least one determined composite expression as an input to a cryptographically verifiable computing algorithm, at least one component of the aggregated signature.

14. The method of claim 13, wherein the cryptographically verifiable computing algorithm is a zero-knowledge proof algorithm, and the at least one determined composite expression is used as a private witness.

15. The method of claim 8, wherein aggregating the signature data associated with the plurality of received transactions to generate the aggregated signature, comprises:
determining, for each transaction, a first parameter, ri, by calculating ri=hash(pki, Txi), where pki is the public key associated with the transaction, and Txi is the transaction data associated with the transaction;
determining a first component, a1, of the aggregated signature, A, by calculating, for each transaction, a first product ri*si,1, where si,1 is a first component of the signature data associated with a transaction, and summing the first product over all transactions to calculate the first aggregate signature component;
determining a second component, a2, of the aggregated signature, A, by calculating, for each transaction, a second product ri*pki*si,2, where si,2 is a second component of the signature data associated with a transaction, and summing the second product over all transactions to calculate the second aggregate signature component; and
determining, using the second aggregate signature component, a2, as an input to a cryptographically verifiable computing algorithm, a third component, π, of the aggregated signature, A.

16. The method of claim 8, wherein aggregating the signature data associated with the plurality of received transactions to generate the aggregated signature, comprises:
determining, for each transaction, a first parameter, qi, such that s1,i=Hash(Txi)−pki s2,i+qi p, where pki is the public key associated with the transaction, Txi is the transaction data associated with the transaction, si,1 is a first component of the signature data associated with the transaction, si,2 is a second component of the signature data associated with the transaction, Hash(Txi) is a hash value of the transaction data with Hash( ) a hash function, and p a prime number; and
executing a zero-knowledge proof algorithm using as a private witness a set of the first parameter, the first signature component and the second signature component for the plurality of received transactions {s1,i, s2,i, qi}, and using as a public instance a set of the public keys and the hash values of the transaction data for the plurality of received transactions {pki, Hash(Txi)} to output the aggregated signature.

17. The method of claim 1, wherein a size of the aggregated signature is less than the sum of the sizes of each signature data associated with each transaction.

18. The method of claim 1, wherein a size of the aggregated signature is sublinear with respect to the total number of transactions.

19. The method of claim 18, wherein the size of the aggregated signature scales logarithmically with respect to the total number of transactions.

20. The method of claim 18, wherein the total number of transactions is greater than a threshold number of transactions for which the size of the aggregated signature is less than a sum of the sizes of each signature data associated with each transaction.

21. The method of claim 1, wherein generating the block of the blockchain comprises updating a pre-generated block including the plurality of received transactions, by replacing signature data comprised in the pre-generated block with the aggregated signature.

22. The method of claim 1, comprising:
running an aggregated signature verification algorithm using the aggregated signature, the plurality of transactions, and a plurality of public keys associated with the plurality of transactions.

23. A method of verifying a transaction in a block of a blockchain using an aggregated signature, the aggregated signature being associated with a plurality of transactions in the block of the blockchain, the aggregated signature being stored in the block of the blockchain separate from the plurality of transactions in the block, and the method comprising:
receiving the aggregated signature; and
verifying the validity of the transaction by executing an aggregated signature verification algorithm to verify the validity of the aggregated signature.

24. A server comprising at least one processor configured to carry out the method of claim 1.
